(19) United States
(12) Patent Application Publication
(10) Pub. No.: US 2008/0000124 A1
(43) Pub. Date: Jan. 3, 2008

(54) Conveyor belt divider

(76) Inventors: Steven Jay Hecht, Wyckoff, NJ (US); Jeffery D. Alexander, Oradell, NJ (US)

Correspondence Address: Karen G. Horowitz;Legal Divison, Warmer-Lambert Company, 201 Tabor Road, Morris Plains, NJ, 07950, US

(21) Appl. No.: 11/824,635

(22) Filed: Jun. 29, 2007

Related U.S. Application Data
(60) Provisional application No. 60/817,713, filed on Jun. 30, 2006.

(51) Int. Cl. G09F 3/18

(52) U.S. Cl. 40/649

(57) ABSTRACT

A conveyor belt divider used to separate different customers' orders on a conveyor belt at a checkout register. The conveyor belt divider is configured to hold a plurality of items, such as small bottles, that may be removed by a customer at a checkout register. A gripping element may be associated with the holding channel in which the items are held to retain the items securely within the holding channel. A stabilizing element may be provided to stabilize the conveyor belt divider to maintain the items held by the conveyor belt divider in an upright position.

### CROSS REFERENCE OF APPLICATION

The present application claims the benefit of the earlier filing date of U.S. Provisional Patent Application 60/817,713, filed Jun. 30, 2006, which application is hereby incorporated by reference herein in its entirety.

### FIELD OF THE INVENTION

The present invention relates to an elongated article (commonly called a conveyor belt divider, order divider bar, or check out counter divider, or other such term, and hereinafter called the first term for the sake of convenience), used to separate different customers' orders on a conveyor belt at a checkout counter or cashier in a store.

### BACKGROUND OF THE INVENTION

Checkout counters in supermarkets and mass merchants and other “super” stores often utilize conveyor belts to permit a customer to unload his/her shopping cart, to convey such items to the cashier for checkout at the cash register, and to keep items moving as the cashier registers the cost of each item. Movement of the items as they are processed by the cashier also permits the next customer to begin unloading his or her shopping cart on the same conveyor belt at a position remote from the cashier and cash register. In order to differentiate different customers' orders (so that items of one customer are not inadvertently intermingled and checked out with items of the preceding customer at the checkout counter), conveyor belt dividers are commonly used to separate one customer's order from another.

One increasingly common use for conveyor belt dividers is as an advertising means. For instance, advertisements for products or services may be displayed by the conveyor belt divider, such as by stickers on the walls of the conveyor belt divider. In a more advanced form, the conveyor belt divider may be formed of clear plastic with an insert therein on which advertising information may be provided for viewing through the clear plastic material. Such configuration permits interchangeability of the information to be displayed.

### SUMMARY OF THE INVENTION

In accordance with the principles of the present invention, a new use for a conveyor belt divider has been devised that not only provides advertising information, but also displays and holds items that may be purchased at the checkout counter. Such items may be, but are not limited to, “impulse” items that otherwise are kept on shelves adjacent or immediately across from the conveyor belt and which a customer sees during checkout and may buy on “impulse.”

The conveyor belt divider of the present invention has a length specifically selected to fit on a conveyor belt used at a standard store checkout counter, and is formed with a channel sized to hold preferably several items therein. A gripping element may be provided within the channel to grip the items so they do not fall out of the channel if the conveyor belt divider is roughly handled by customers or simply dropped onto the conveyor belt. If desired, such gripping element may be formed to accommodate items of varying sizes so that different sized items may be placed in the channel yet still be securely held therein. A panel may be provided for additional advertising information.

If desired, a stabilizing element may be provided to stabilize the conveyor belt divider so it does not topple over because of the weight distribution of the items held by the conveyor belt divider.

### BRIEF DESCRIPTION OF THE DRAWINGS

The detailed description will be better understood in conjunction with the accompanying drawings, wherein like reference characters represent like elements, and in which:

FIG. 1 is a perspective view of an exemplary conveyor belt divider formed in accordance with principles of the present invention;

FIG. 2 is a side elevational view of the conveyor belt divider of FIG. 1;

FIG. 3 is a perspective view of an exemplary gripping element such as may be used in the conveyor belt divider of FIGS. 1 and 2;

FIG. 4 is a side elevational view of another exemplary embodiment of a conveyor belt divider formed in accordance with principles of the present invention;

FIG. 5 is a side elevational view of yet another exemplary embodiment of a conveyor belt divider formed in accordance with principles of the present invention; and

FIG. 6 is a side elevational view of an exemplary conveyor belt divider similar to the conveyor belt divider of FIG. 1, but with item dividers in the holding channel thereof.

### DETAILED DESCRIPTION OF THE INVENTION

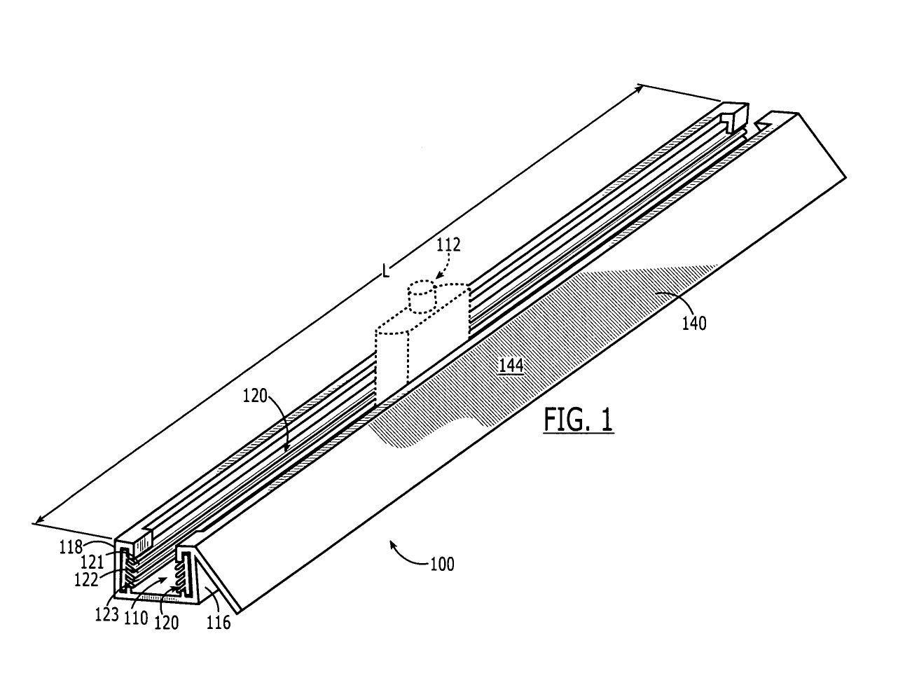

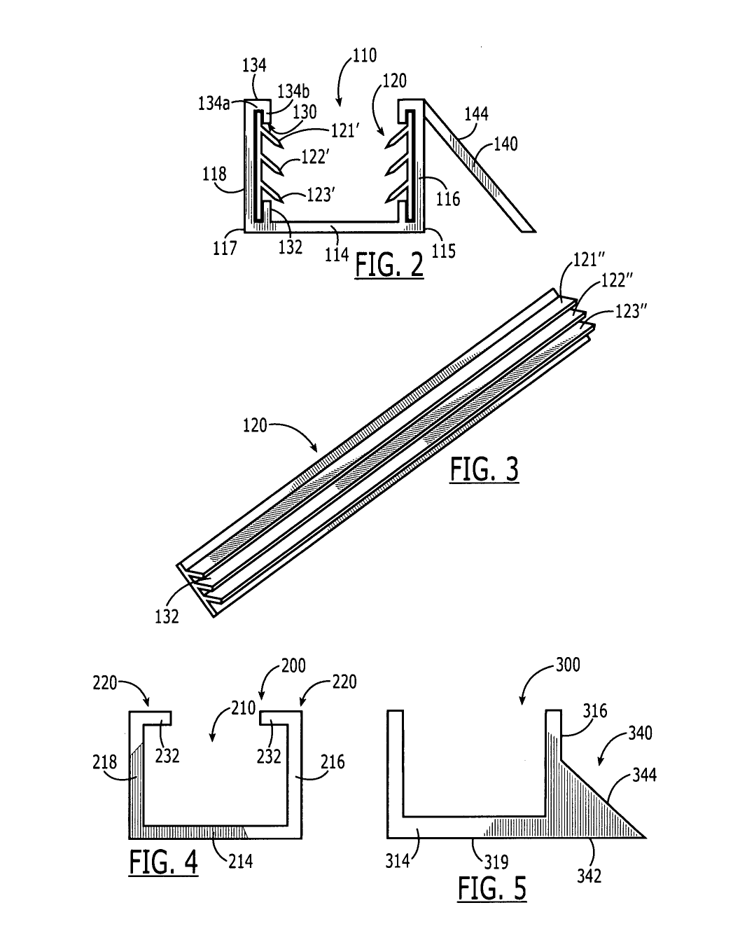

In accordance with the principles of the present invention, an exemplary conveyor belt divider 100, such as illustrated in FIG. 1, is formed with a holding channel 110 configured for displaying and holding at least one and preferably a plurality of items 112. Preferably, the items 112 to be held by a conveyor belt divider of the present invention include consumer items intended to be used, and most preferably purchased, by the customer. As illustrated in FIG. 2, holding channel 110 of exemplary conveyor belt divider 100 is formed by a bottom wall 114, a front side wall 116 extending from and along a front edge 115 of said bottom wall 114, and a back side wall 118 extending from and along a back edge 117 of said bottom wall 114. Length L of conveyor belt divider 100 is specifically selected to extend across a substantial part of the width of a standard conveyor belt for items at a checkout counter of a store. Thus, conveyor belt divider 100 is specifically configured for use as a divider bar to be placed between different customer orders on a conveyor belt at a checkout counter.

A conveyor belt divider formed in accordance with the principles of the present invention may be used to attract customer attention to a particular item 112 displayed by and held within holding channel 110. Conveyor belt divider 100 thus may be used to display items such as for advertising purposes. In such instance, holding channel 110 may be configured to hold items 112 firmly therein. Alternatively, items 112 may be “impulse” items that are commonly found at checkout counters and are at a low enough price point that a customer will notice such item during checkout and purchase such item out of impulse. If impulse items are displayed by conveyor belt divider 100, then such items are preferably removably held within holding channel 110 so that a customer may remove and purchase such item with relative ease.

In order to hold items 112 securely within holding channel 110 such that the items do not fall out during use of conveyor belt divider 100, a gripping element may be formed within or adjacent holding channel 110. Such gripping element may be in any desired form to achieve the goal of holding the items 112 within holding channel 110. For instance, resilient fingers (such as leaf springs formed from channel side walls 116, 118) may extend inwardly from side walls 116, 118 into channel 120 to exert pressure on an item 112 to retain such item 112 within channel 120. In the embodiment of FIG. 1, a gripping element that relies on friction to retain items 112 within holding channel 110 (hereinafter a “frictional gripping element 120”) is provided, preferably along the interior, channel-facing side of each side wall 116, 118. Frictional gripping element 120 may be in any desired form to achieve the desired function of holding items 112 in holding channel 110 via friction. In the exemplary embodiment of FIG. 1, frictional gripping element 120 has a plurality of fingers 121, 122, 123 that hold items 112 in place. It will be appreciated that the precise number, shape, arrangement, and length of fingers 121, 122, 123 may be modified as desired. Determination of the number, shape, arrangement, length, etc. of fingers 121, 122, 123 may be based on a variety of factors, such as the size of the item 112 to be held within holding channel 110, or the material from which item 112 is formed. For instance, longer fingers may be used to hold an item within holding channel 110 if the walls of the item would be spaced apart from side walls 116, 118 were shorter fingers present. Additionally or alternatively, the free ends may have any of a variety of cross-sectional shapes. For instance, gripping element 120 may have fingers 121′, 122′, and 123′ with tapered free ends as illustrated in FIG. 2, or fingers 121″, 122″, and 123″ with squared-off free ends as in FIG. 3. Any number of combinations of such fingers may be provided on a given gripping element 120.

To facilitate use of conveyor belt divider 100 for a variety of items, such that conveyor belt divider 100 is not limited to use for only one particular type of item 112, frictional gripping element 120 may configured to be removable from holding channel 110. For instance, as illustrated in FIGS. 2 and 3, frictional gripping element 120 may be in the form of a strip removably held within a retaining channel 130 in the interior, channel-facing side of each of side walls 116, 118 along which a frictional gripping element 120 is provided. Retaining channel 130 may be formed by a lower retaining wall 132 upwardly extending from bottom wall 114 and an upper retaining wall 134 extending from the upper edge of the side wall 116, 118 in which retaining channel 130 is formed, as illustrated in FIGS. 1 and 2. In the embodiment of FIGS. 1 and 2, upper retaining wall 134 is formed from a horizontal leg 134a and a downwardly extending vertical leg 134b. However, other configurations for an upper retaining wall are well within the scope of the present invention. Lower retaining wall 132 and upper retaining wall 134 are sufficiently spaced from the side wall 116, 118 in which retaining channel 130 is formed to hold frictional gripping element 120 in place so that it does not fall out when no items 112 are within holding channel 110, yet to permit frictional gripping element 120 to be removed and replaced readily, as desired, with a differently configured frictional gripping element 120. It will be appreciated that retainers other than a retaining channel may be used to retain a gripping element within holding channel 110 as desired yet to permit ready removability.

To further facilitate interchangeability of gripping elements, the gripping elements themselves may be particularly configured to facilitate interchangeability. For instance, frictional gripping element 120 illustrated in FIG. 3 may be formed of a low friction backing strip 132 from which elastomeric fingers 121, 122, 123, or 121′, 122′, 123′, or 121″, 122″ 123″, extend (formed, for example, by a co-extrusion or co-molding process). The use of a low-friction material for the backing strip 132 allows for ready sliding into and out of a retainer such as retaining channel 130 while still permitting for the use of frictional forces to retain items 112 within holding channel 110.

It will be appreciated that the gripping element used to retain items 112 within a holding channel may be formed in any desired manner and to achieve the gripping function in any desired manner. For example, a conveyor belt divider 200 may be formed with side walls 216, 218 configured to form an interference gripping element 220, as illustrated in FIG. 4. In the embodiment of FIG. 4, interference gripping element 220 is formed from holding fingers 232 that partially enclose holding channel 210 such that holding fingers 232 block (essentially prevent) an item 112 from inadvertently falling out of holding channel 210. Of course, other configurations of an interference gripping element 220 that hold an item within holding channel 210 by interference (such as blocking movement of the item) are within the scope of the present invention.

As stated earlier, conveyor belt dividers formed in accordance with the principles of the present invention are specifically formed to be used on conveyor belts at a checkout counter, and are specifically configured to display and to hold items in a channel therein. Thus, a stabilizing element may be desirable to maintain the upright position of items 112 held by conveyor belt dividers of the present invention. An exemplary stabilizing panel 140, such as illustrated in FIGS. 1 and 2, may be used along one or both sides of the conveyor belt divider. As may be appreciated with reference to FIG. 2, exemplary stabilizing panel 140 extends from an upper end of front side wall 116 downwardly at an angle with respect to front side wall 116. Such extension of stabilizing panel 140 serves to stabilize a conveyor belt divider 100 that may be somewhat top heavy because of items 112 held therein. Alternatively, a stabilizing element may be in the form of an extension along one or both of the side walls of the conveyor belt divider, such as stabilizing extension 340 extending from a front side wall 316 of the exemplary conveyor belt divider 300 of FIG. 5. Exemplary stabilizing extension 340 is formed as a substantially solid extension (in contrast with the mere panel 140 spaced from the main front side wall 116 of conveyor belt divider 100 of FIGS. 1 and 2) protruding from front side panel 316. Such stabilizing extension 340 may extend the entire length of conveyor belt divider 300, or may be in the form of several spaced apart protrusions along the length of conveyor belt divider 300 (such as “feet”). The configuration of stabilizing extension 340 may be determined based on various factors. For instance, if conveyor belt divider 300 is to be extruded, then the extrusion process may impose limitations on the thickness of stabilizing extension 340 (such as a result of different cooling rates during the extrusion process, which may cause warping). In the embodiment of FIG. 5, stabilizing extension 340 has a bottom surface 342 substantially aligned with and extending from bottom surface 319 of bottom wall 314. Of course, if conveyor belt divider 300 is to be specifically designed to fit and to be stored in a channel typically provided along a conveyor belt at a checkout counter, then it may be desirable to provide at least a notch along bottoms surfaces 319, 342 to accommodate the wall of such storage channel. It will be appreciated that any other stabilizing element that achieves the desired effect of maintaining items 112 within a holding channel of a conveyor belt divider of the present invention are within the scope of the present invention as well.

As described previously, conveyor belt dividers commonly are used to display information (e.g., text or graphics), such as advertising information. Any desired surface of a conveyor belt divider formed in accordance with the principles of the present invention may be so used. If a stabilizing element is provided on a conveyor belt divider formed in accordance with the principles of the present invention, information may be displayed on a front surface of such stabilizing element. For instance, information may be provided on an outer display surface 144 of stabilizing panel 140 of conveyor belt divider 100 of FIGS. 1 and 2, or on an outer display surface 344 of stabilizing extension 340 of conveyor belt divider 300 of FIG. 5. Such information may be provided in any desired manner, such as direct imprinting, application of a separate panel or sticker bearing such information, or insertion of a panel or other information-bearing element in a retaining element on stabilizing panel 140 or stabilizing extension 340 to permit interchangeability of information (similar in concept to the interchangeability of gripping elements 120 afforded by retaining channel 130 of conveyor belt divider 100 of FIGS. 1 and 2).

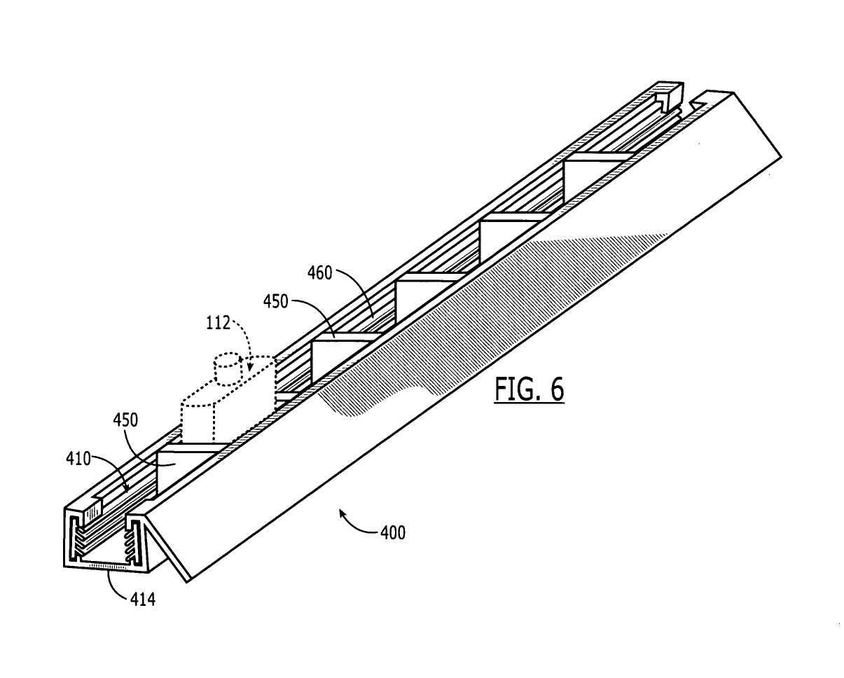

It will be appreciated that various modifications to conveyor belt dividers formed in accordance with the principles of the present invention to enhance the product holding and displaying functions thereof may be implemented. For instance, it may be desirable to form individual compartments for each item 112 to be held by the conveyor belt divider. Such compartments may aid in keeping items 112 aligned and/or upright within the conveyor belt divider channel, or in separating the items 112 within the holding channel, or in facilitating orderly insertion of items 112 upon refilling of the holding channel (such as if the holding channel is only partially filled, the compartments readily indicate the number of items to be filled and delineate and reserve the space for such item). Furthermore, such compartments may be specially shaped to enhance gripping or stabilization of the item 112 to be held therein. Specially shaped inserts may be provided within such compartments to further facilitate holding of the items within the holding channel of the conveyor belt divider. As illustrated in FIG. 6, a conveyor belt divider 400 may be provided with dividers 450 within holding channel 410 to define individual compartments 460 for each item 112 to be held therein. Such dividers 450 may be formed as upright panels extending from bottom wall 414 of conveyor belt divider 400. Dividers 450 may be fixedly or movably coupled to bottom wall 414. Movable coupling of dividers 450 may be effectuated in any of a variety of manners. For instance, dividers 450 may be slidably coupled to bottom wall 414 for slidable movement within holding channel 420 to permit adjustment of the width of compartments 460 to accommodate differently sized items 112.

Another adjustment to conveyor belt dividers formed in accordance with the principles of the present invention may be directed to improving the gripping of items 112 held therein. For instance, the outer surfaces of the side walls or stabilizing elements may be textured or otherwise modified to facilitate or to enhance gripping of the conveyor belt divider itself (instead of gripping of the items held thereby). Alternatively, or additionally, it may be desirable to add further features to assure that when a customer lifts and moves the conveyor belt divider (such as with forces not as gentle as may be warranted) or places the conveyor belt divider on a conveyor belt (such as by dropping), items 112 are not displaced from the holding channel. One such feature may be to add grasping features so that customers can readily grasp and manipulate the body of the conveyor belt divider itself without grasping items 112. For instance, the height of the side walls of the conveyor belt divider may be increased so that customers grasp the body of the conveyor belt divider (e.g, the side walls, or bottom wall, or even a stabilizing element if present) rather than the items 112 held therein. Preferably, if the side walls extend sufficiently high enough to protect the items 112 from being grasped instead of the conveyor belt divider body, at least the portion of the side walls adjacent the side walls of items 112 is formed of a transparent material to permit ready viewing of items 112. A simple handle or ledge may be provided, instead, along either or both sides of the conveyor belt divider. Alternatively, another grasping element, such as hooks at the free ends of the conveyor belt divider (along its longitudinal axis) may be provided. The shape of the conveyor belt may be altered to facilitate grasping, such as by providing indentations or cutouts or surface texturing (such as ribs or other roughening to enhance grasping) along either or both of side walls 116, 118 or stabilizing panel 140.

It will be appreciated that the various features that may be provided on a conveyor belt divider with a holding channel as described above may be used individually or in any combination. For instance, a conveyor belt divider with the stabilizing extension 340 of FIG. 5 may be used with either of the gripping elements 120, 220 or another configuration of a gripping element.

While a conveyor belt divider formed in accordance with the principles of the present invention is particularly shown and described herein with reference to the particular embodiment illustrated in the drawings, it is to be understood that the present invention may be used with many additions, substitutions, or modifications of form, structure, arrangement, proportions, materials, and components and otherwise, used in the practice of the invention, which are particularly adapted to specific environments and operative requirements without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. The presently disclosed embodiments are therefore to be considered in all respects as illustrative and not restrictive, the scope of the invention being indicated by the appended claims, and not limited to the foregoing description.

What is claimed is:

1. A conveyor belt divider comprising:
a bottom wall and at least one side wall defining a holding channel configured to hold at least one consumer item therein;
wherein said bottom wall and said at least one side wall have a length selected to conform to the length of a standard conveyor belt at a checkout counter of a store.

2. A conveyor belt divider as in claim 1, wherein said at least one side wall includes a front side wall and a back side wall spaced apart from each other by said bottom wall and defining said holding channel therebetween.

3. A conveyor belt divider as in claim 1, further comprising a gripping element associated with said holding channel to hold consumer items within said holding channel.

4. A conveyor belt divider as in claim 3, wherein said gripping element comprises a frictional element configured to hold a consumer item within said holding channel by frictional forces.

5. A conveyor belt divider as in claim 4, further comprising a retaining channel within said at least one side wall, wherein:
said gripping element and said retaining channel are configured for removable insertion of said gripping element into said retaining channel and retention therein; and
said gripping element comprises a low-friction backing strip configured for slidable insertion into said retaining channel and frictional gripping elements extending from said low-friction backing strip and into said holding channel to engage and to hold a consumer item within said holding channel via frictional forces.

6. A conveyor belt divider as in claim 3, wherein said gripping element is shaped to interfere with movement of a consumer item out of said holding channel.

7. A conveyor belt divider as in claim 1, further comprising a stabilizing element configured to maintain said conveyor belt divider in a position maintaining consumer items within said holding channel in an upright position.

8. A conveyor belt divider as in claim 7, wherein said stabilizing element is in the form of a stabilizing panel extending away from said at least one side wall and in a direction of said bottom wall.

9. A conveyor belt divider as in claim 7, wherein said stabilizing element is in the form of an extension projecting from said at least one side wall.

10. A conveyor belt divider as in claim 7, wherein said stabilizing element is configured to bear and to display information.

11. A conveyor belt divider as in claim 1, further comprising dividers positioned within said holding channel to delineate compartments for individual consumer items to be held in said holding channel.

12. A conveyor belt divider as in claim 11, wherein said dividers are movable.

13. A conveyor belt divider as in claim 11, further comprising inserts shaped for insertion into said compartments and for retaining consumer items securely within said holding channel.

14. A method of holding consumer items in a conveyor belt divider, said method comprising:
providing a conveyor belt divider, having a length selected to conform to the length of a standard conveyor belt at a checkout counter of a store, with a holding channel configured for holding consumer items therein;
placing consumer items within said holding channel for display by said conveyor belt divider.

15. A method as in claim 14, further comprising:
associating a gripping element with said holding channel to facilitate holding of the consumer items within said holding channel; and
placing said consumer items within said holding channel.

16. A method as in claim 15, further comprising:
associating said gripping element to permit interchangeability of gripping elements; and
changing said gripping element as needed to conform to different consumer items to hold such different consumer items securely within said holding channel.

17. A conveyor belt divider comprising:
a bottom wall having a front edge and a back edge and a length selected to conform to the length of a standard conveyor belt at a checkout counter of a store;
a front side wall extending upwardly along and from said front edge of said bottom wall; and
a back side wall extending upwardly along and from said back edge of said bottom wall and spaced apart from said front side wall;
wherein:
sad bottom wall, said front side wall, and said back side wall define a holding channel therebetween configured to hold at least one consumer item therein; and
a gripping element is associated with said holding channel to retain said consumer item within said holding channel.

18. A conveyor belt divider as in claim 17, wherein said gripping element comprises a frictional element configured to hold a consumer item within said holding channel by frictional forces.

19. A conveyor belt divider as in claim 18, further comprising a retaining channel within said at least one side wall, wherein:
said gripping element and said retaining channel are configured for removable insertion of said gripping element into said retaining channel and retention therein; and
said gripping element comprises a low-friction backing strip configured for slidable insertion into said retaining channel and frictional gripping elements extending from said low-friction backing strip and into said holding channel to engage and to hold a consumer item within said holding channel via frictional forces.

20. A conveyor belt divider as in claim 17, wherein said gripping element is shaped to interfere with movement of a consumer item out of said holding channel.

21. A conveyor belt divider as in claim 17, further comprising a stabilizing element configured to maintain said conveyor belt divider in a position maintaining consumer items within said holding channel in an upright position.

22. A conveyor belt divider as in claim 21, wherein said stabilizing element is in the form of a stabilizing panel extending away from said at least one side wall and in a direction of said bottom wall.

23. A conveyor belt divider as in claim 21, wherein said stabilizing element is in the form of an extension projecting from said at least one side wall.

24. A conveyor belt divider as in claim 17, further comprising dividers positioned within said holding channel to delineate compartments for individual consumer items to be held in said holding channel.

25. A conveyor belt divider as in claim 24, wherein said dividers are movable.

26. A conveyor belt divider as in claim 24, further comprising inserts shaped for insertion into said compartments and for retaining consumer items securely within said holding channel.
